(19) United States
(12) Patent Application Publication
(10) Pub. No.: US 2010/0064062 A1
(43) Pub. Date: Mar. 11, 2010

(54) METHOD FOR THE CONTROL OF AN ELECTRONIC RADIO COMMUNICATION MODULE

(75) Inventors: Didier Lahay, Versailles (FR); Jacques Montes, Le Perreux Sur Marne (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: WAVECOM, Issy-Les-Moulineaux (FR)

(21) Appl. No.: 12/303,698

(22) PCT Filed: Jun. 1, 2007
(86) PCT No.: PCT/EP07/55417

§ 371 Date: May 7, 2009

(30) Foreign Application Priority Data
Jun. 7, 2006 (FR) 0605065

(51) Int. Cl. G06F 3/00

(52) U.S. Cl. 710/5

(57) ABSTRACT

A method is provided for the control of an electronic radio communication module using a first device. The method includes a step of detection by a second device of the available control interface(s) of the module, the second device being the same as or separate from the first device. The detection step includes a step in which the second device obtains a description file containing the available control interface/s of the module. The description file is a WSDL file describing the available control interface(s) of the module in the form of at least one Web service hosted by the module. The Web service can be described, in the WSDL file, by reusing the AT command syntax.

### CROSS-REFERENCE TO RELATED APPLICATIONS

This application is a Section 371 National Stage Application of International Application No. PCT/EP2007/055417, filed Jun. 1, 2007 and published as WO 2007/141215 on Dec. 13, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of radio communications, and more precisely of digital radio communication terminals (also referred to as radio communication devices), whether entailing radio telephones or devices or means of all types able to exchange signals using a radio communication system, implanted for example in machines or vehicles.

More precisely, the disclosure relates to a technique for controlling a radio communication terminal by a device that is connected to it. The device is for example a microcomputer executing a client application. The device is connected to the radio communication terminal, either locally (for example via a serial link or USB), or remotely (for example through a wired or wireless radio communication network).

### BACKGROUND OF THE DISCLOSURE

### 1. Component-Based Radio Communication Devices

Most radio communication devices include, conventionally, a set of electronic components implanted on a printed circuit. The purpose of these various components is to provide the various necessary functions, from the reception of a RF signal to the generation of an audible signal (in the case of a radiotelephone), and inversely. Certain of these functions are analogue, and other are digital.

Much research is being devoted to the manufacture of these radio communication devices. Indeed, the aim concerns at least three objectives that are difficult to reconcile: miniaturising the devices, increasing and adapting the functionalities, and simplifying assembly. It is known in particular that the implantation of the various components on the printed circuit is a relatively complex operation, many components have to be set in place on a surface that is smaller and smaller, due to the requirements concerning miniaturisation.

The design of these systems is therefore complex, since it further requires associating diverse components, often from multiple sources, that have to be made to operate together, while complying with the specificities of each one. Moreover, after the assembly of all of the components, calibration and testing phases, often long and complex, are necessary in order to guarantee the proper operation of the device. Finally, despite the reduction in size of certain components, the whole occupies a certain surface area, which is difficult to reduce.

### 2. Module-Based Radio Communication Devices

The holder of this application has proposed an approach that overcomes a certain number of these disadvantages, consisting in regrouping in a single module (called electronic radio communication module), all or at least most of the functions of a digital radio communication device.

Such a module is shown in the form of a single housing, preferentially shielded, that the device manufacturers can implant directly, without having to take a multitude of components into account.

This module (still sometimes referred to as “macro component”) is indeed formed of a grouping of several components on a substrate, in such a way as to be embedded in the form of a single element. It includes the components (in particular a processor and a memory) and the essential software needed for the operation of a radio communication device (also referred to as radio communication terminal or wireless terminal) using radio frequencies. Therefore, there are no longer any complex steps in the designing, and in the validating of the latter. It is sufficient to reserve the necessary space for the module.

Such a module thus makes it possible to integrate all of the components into wireless terminals (portable telephones, modems, or any other device making use of a wireless standard) easily, rapidly and in an optimised manner.

Moreover, this module grouping together all of the essential functions and having been designed as a whole, the problems with calibration and testing are no longer issues in the same way, or are in the least, greatly simplified.

As such, the modules distributed by the holder of this application are fully tested from a hardware as well as a software standpoint on most of the networks on which they can then be used. Furthermore, the module advantageously encompasses the aspects of intellectual property (or IPRs, for “Intellectual Property Rights”) (all of the functions have been grouped together, it is the manufacturer of the module who handles aspects concerning the corresponding industrial property rights) and technical assistance.

The aforementioned module is for example a module of the Wismo type (registered trademark) distributed by the applicant of this patent application.

### 3. Disadvantages of Prior Art

Despite these undeniable advantages, this technique has several disadvantages.

A first disadvantage resides in the difficulties encountered by developers of applications intended to be executed by the devices driving the modules.

Indeed, the developer of an application for a device intended to drive a given radio communication module must know the available control interface(s) on this module. For this, he must consult the documents that are specific to this given module, which describe the control interfaces for it.

As such, in the conventional case wherein the radio communication module is driven with AT commands, the developer must imperatively become aware, without any way of automating this, of the documents that textually define the AT commands supported by this module, as well as the physical interfaces (for example RS232, USB, etc. for a wired interface, and Zigbee, Wifi, GPRS, etc. for a wireless interface) and the protocols (for example Raw data, http/TCP/IP, etc.) on which these commands are supported. These documents are issued by the supplier (manufacturer) of the module in question. Recall that the AT commands (for “ATtention command”) make it possible for the device to require the radio communication module to which it is connected to execute certain predetermined actions. For more details concerning these AT commands, reference can be made in particular to the “GSM 07.07” standard from ETSI and the V25ter recommendation from ITU-T.

This acknowledgement by the developer is further complicated by the fact that, even if a standardised set of commands exists (for example in the aforementioned “GSM 07.07” standard), it may be that the module to be driven does not support all of them and that this has to be taken into account in the development of the application executed by the device.

This acknowledgement by the developer is also complicated by the fact that certain commands may be proprietary (i.e. specific to a radio communication module supplier) and are described only in the technical documentation provided by this supplier for the module in question.

Another disadvantage with prior art is that an application that is already developed, and that makes it possible for a device to drive a module with a given control interface of this module, must be at least partially written (and therefore cannot be reused as is) in order to allow a device to drive the same module with another control interface, or another module.

Yet another disadvantage with prior art is that during the usage phase (i.e. when the device is connected to a radio communication module in order to drive it by executing an application developed beforehand), the device cannot dynamically adapt its operation according to the module to which it is effectively connected (and to the available control interface of this module).

### SUMMARY

In a particular embodiment of the invention, a method is proposed for controlling an electronic radio communication module by a first device comprising a step of discovery by a second device of the available control interface(s) of said module, said second device being the same as or separate from said first device. Said step of discovery comprises a step of obtaining by the second device of a description file containing the available control interface(s) of said module, said description file being a WSDL file describing the available control interface(s) of said module in the form of at least one Web service hosted par said module.

The general principle of an embodiment of the invention therefore consists in automatically exporting, to the device, the information relating to the control interface(s) of the module.

The module acts, in the sense of Web services technologies, as an end point that can be accessed by any Web client (i.e. any device desiring to drive it). The control interface(s) of the module are described in a service contract materialised in a WSDL file.

Advantageously, each available control interface of said module is defined by:
a set of commands supported by the module;
a physical interface of the module on which said set of commands is supported;
a protocol on which said set of commands is supported.

Advantageously, said second device obtains the description file:
locally, thanks to a connection between the second device and the module, said description file being stored by the module; or
remotely, thanks to a connection between the second device and another remote device, said description file being stored by said other remote device.

In a particular embodiment, said module hosts and executes a main radio communication software and an on-board client software. Furthermore, said WSDL file describes at least one Web service which is provided by said client software and which uses at least one available control interface of the module.

The context (known) here is herein the supplier of the radio communication module allows each client to embed on the module a client application which is proper to it. The novelty comes from the fact that the supplier of the module further offers to each client the possibility of integrating one or several Web services in the client application. In other words, an exporting of the business interfaces of the customer is allowed, in the form of Web services.

Advantageously, said at least one Web service is described, in said WSDL file, by reusing the AT command syntax.

As such, in this case, compatibility is maintained with the current AT commands, by encapsulating them in generic Web services. In this way, the device drives the module by sending it commands that, due to the fact that they comply with the syntax of AT commands, can be processed by the portion of the main software of the module that processes the AT commands. In other words, it is not necessary for the module to further include a software layer specific for the Web services.

In the case where the client application is on board the module and that this client application exposes new AT commands, the latter can be exposed in the same way as those supported natively on the module.

According to an advantageous alternative, said at least one Web service is described, in said WSDL file, by using a syntax that is separate from that of the AT commands.

In this alternative, this entails an implementation that makes a clean sweep of the current AT commands, the interfaces of the module being redefined in the Web services format. It is necessary for the module to include a software layer that is specific to the Web services (called hereinafter “Modem UF” or “Web Services API”, for “Web Services Application Programming Interface”).

According to an advantageous alternative, said step of discovery is followed by the following steps:
selecting a control interface of the module, from among available control interface(s) discovered beforehand;
driving of said module by said first device, according to the control interface selected.

In a first particular embodiment of the invention, said steps of discovering and of selecting are carried out with said second device, during a development phase of an application and/or a software layer (Modem Driver) on which said application is based, intended to be hosted and executed by said first device, said step of selection being carried out by a developer, said development being according to the control interface selected. Furthermore, said step of driving is carried out during a later usage phase of said first device in cooperation with said module.

As such, the development of the application executed by the device is facilitated.

In a second particular embodiment of the invention, the second device is the same as the first device. Furthermore, said steps of discovering, selecting and driving are carried out during a usage phase of said first device in cooperation with said module, said step of selection being carried out automatically and dynamically by said first device, according on the one hand to a predetermined selection policy and on the other hand to the available control interface(s) discovered.

In this way, the device can dynamically adapt its operation according to the module to which it is effectively connected (and the available control interface of this module).

For example, an application can provide for managing right from the design stage modules coming from several suppliers, each having specificities. In the step of discovering of the interfaces, the application adapts if the case has been provided for in the design stage. For example, a remote application server can be provided to have a compatibility with a maximum of different possible modules and therefore decide, after the step of discovering, the interfaces to be used according to those available on the module in question.

In another embodiment, the invention relates to a device of the type making it possible to cooperate with an electronic radio communication module. This device comprises means of discovering the available control interface(s) of said module, in such a way as to allow for the controlling of said module by said device or by another device. Said means of discovering include means of obtaining via said device of a description file containing the available control interface(s) of said module, said description file being a WSDL file describing the available control interface(s) of said module in the form of at least one Web service hosted by said module.

More generally, the device according to an embodiment of the invention comprises means of implementing the method of control such as described hereinabove (in any one of its various embodiments).

In another embodiment, the invention relates to an electronic radio communication module, of the type able to be controlled by a first device, said module hosting at least one Web service, a WSDL file describing the available control interface(s) of said module in the form of said at least one Web service.

In another embodiment, the invention relates to a recording support containing a description file associated to an electronic radio communication module, said module being of the type able to be controlled by a first device, said description file being a WSDL file describing the available control interface(s) of said module in the form of at least one Web service hosted by said module, said description file being intended to be stored locally on the module or remotely on another device,

said file being intended to be obtained by a second device, the same as or separate from said first device, in such a way as to allow the first device to control the module.

### BRIEF DESCRIPTION OF THE DRAWINGS

Other characteristics and advantages of embodiments of the invention shall appear during the reading of the following description of several particular embodiments of the invention, given by way of an informative and non-limiting example, and the annexed drawings, wherein:

FIG. 1 shows a flow chart of a particular embodiment of the method according to the invention;

FIG. 2 shows a functional block diagram of a radio communication module and two devices (one local and the other remote), showing the first and second embodiments of the method according to the invention;

FIG. 3 shows a functional block diagram of a radio communication module and two devices (one local and the other remote), showing a third and fourth embodiments of the method according to the invention;

FIG. 4 shows a functional block diagram of a radio communication module and two devices (local), showing a fifth embodiment of the method according to the invention;

FIG. 5 shows a first example of an application of the method of the invention, in the case of a water meter driving a radio communication module in order to communicate with a collection server; and

FIG. 6 shows a second example of an application of the method of the invention, in the case of a collection server driving a radio communication module embedding a client application offset from a water meter to the module.

### DETAILED DESCRIPTION OF ILLUSTRATIVE EMBODIMENTS

On all of the figures in this document, the identical elements and steps are designated by a same numerical reference.

### 1. General Principle of an Embodiment of the Invention

An embodiment of the invention therefore relates to a method of controlling an electronic radio communication module by a device.

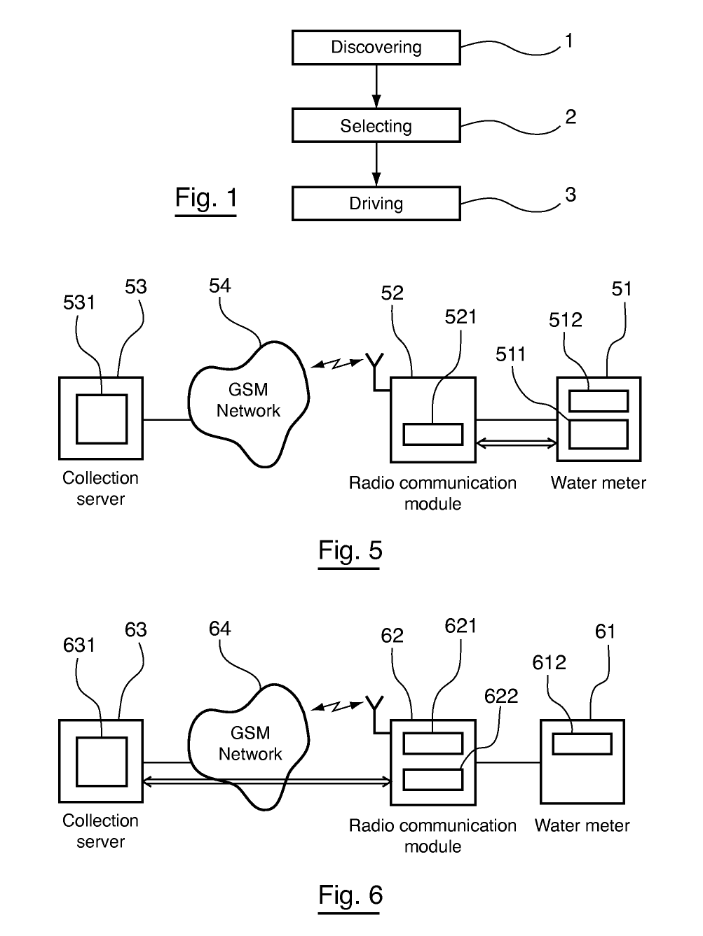

As shown in the flow chart in FIG. 1, the method comprises:
a step 1 of discovering by the device of the available control interface(s) of the module;
a step 2 of selecting a control interface of the module, from among the available control interface(s) discovered beforehand;
a step 3 of driving the module by the device, according to the control interface selected.

For the exchanges between the module and the device, different command formats can be considered for the steps of discovering, selecting and driving, while still remaining within the scope of this invention.

By way of example, the three following cases are described hereinafter in more detail:
use of AT commands for the exchanges between the module and the device;
use of Web services for the exchanges between the module and the device;
use of AT commands and Web services for the exchanges between the module and the device.

FIG. 5 shows a first example of an application of the method of an embodiment of the invention: a water meter 51 drives a radio communication module 52 in order to communicate, via a radio communication network 54 (GSM network for example), with a collection server 53.

During the development phase of a first client application 511 intended to be executed by the water meter 51, the latter, or more often in practice another device (for example a PC) specific to the development, communicates with the module 52 in order to know the available control interface of the module (step 1 of discovering).

Then, in this same development phase, the developer selects one of the available control interfaces discovered beforehand (step 2 of selecting), and takes into account the interface selected in the development that he is carrying out.

During a later usage phase of the water meter 51, the driving of the module takes place for example as follows (step 3 of driving). At a fixed frequency (once a month for example), the first client application 511 executed by the water meter 51 obtains from a sensor 512 information relating to the quantity of water consumed. Then it drives the module 52, by sending commands to a main radio communication application 521 executed by the module, in order to send this information to a second client application 531 executed by the collection server 53. This transmission takes place for example in the form of sending a message of the SMS type by the module 52.

In an alternative of this first example of an application of the method of the invention, the steps of discovering and of selecting are carried out during the usage phase. More precisely, the step of selecting is carried out automatically and dynamically by the water meter 51, according on the one hand to a predetermined selection policy and on the other hand to the available control interface(s) discovered.

FIG. 6 shows a second example of an application of the method of an embodiment of the invention: a collection server 63 drives, via a radio communication network 64 (GSM network for example), a radio communication module 62 embedding a first client application 622 offset from a water meter 61 to the module.

This here lies within one of the possible contexts of the “Open AT” technique (registered trademark), such as is described in detail in French patent FR 2 822 627 published on 27 Sep. 2002, and of which the applicant of this patent application is the holder. In this second example, and in accordance with one of the possible contexts of the “Open AT” technique (registered trademark), the radio communication module 62 executes on the one hand a main radio communication application 621 and on the other hand the first aforementioned client application 622.

During the development phase of a second client application 631 executed by the collection server 63, the latter (or another device, for example a PC, specific to the development) communicates with the module 62 in order to know the available control interface of the module (step 1 of discovering).

Possibly, the available control interface also make it possible to expose the AT commands by the on-board application.

Then, in this same development phase, the developer selects one of the available control interfaces discovered beforehand (step 2 of selecting), and takes into account the interface selected in the development that he is carrying out.

During a later usage phase of the collection server 63, the driving of the module takes place for example as follows (step 3 of driving). At a fixed frequency (once a month for example), the second client application 631 executed by the collection server 63 drives the module 62, so that the first client application 622 obtains from a sensor 612 (comprised in the water meter 61) information relating to the quantity of water consumed and sends this information back to the second client application 631. The sending of this response takes place for example in the form of sending a message of the SMS type by the module 62.

In an alternative of this second example of an application of the method of the invention, the steps of discovering and of selecting are carried out during the usage phase. More precisely, the step of selecting is carried out automatically and dynamically by the collection server 63, according on the one hand to a predetermined selection policy and on the other hand to the available control interface(s) discovered.

### 2. Implementation with the Use of the AT Commands

In relation with FIG. 2, first and second embodiments of the method according to the invention are shown, based on the use of AT commands for the exchanges between the module 21 and a local device 22 (first embodiment), or between the module 21 and a remote device 23 (second embodiment).

The radio communication module 21 comprises:
a main radio communication application 211, itself comprising a portion 212 dedicated to processing AT commands. The main radio communication application 211 is also called “modem software” (such as in FIG. 2), due to the fact that the radio communication module plays the role of a wireless modem). With a concern for simplification, the storage (memory) and execution (CPU) resources of this main application, within the module 21, are not shown in FIG. 2;
a “GPRS” interface 214;
an “HTTP-TCP-IP” layer 213 (above the “GPRS” interface 214);
a “USB” interface 215;
an “RS232” interface 216; and
an “Ethernet” interface 217.

The local device 22 comprises a local client application 221, a “USB” interface 222, an “RS232” interface 223 and an “Ethernet” interface 224. It is connected to the module 21 by the intermediary of a local link 24 (USB, RS232 or Ethernet link in this example), on which the AT commands transit.

The remote device 23 comprises a remote client application 231 and a “HTTP-TCP-IP” layer 232, above a “GPRS” interface 233. It is connected to the module 21 by the intermediary of a remote link 25 (GPRS/IP link in this example), on which the AT commands transit (the latter are encapsulated in IP packets).

With a concern for simplification, the storage (memory) and execution (CPU) resources of the local 221 and remote 231 client applications, within the local device 22 and the remote device 23 respectively, are not shown in FIG. 2.

In order to implement the step of discovering (referenced as 1 in FIG. 1), the device 22 or 23 uses one or several new AT commands (which are a part of an embodiment of this invention) making it possible for the device to retrieve the AT commands supported by the module 21.

A new command, called for example “AT+HELP ATCmdSet”, is such that if the device sends it to the module, the latter sends as a response the list of AT commands that it supports, such as for example:
AT+CPIN?
AT+CPIN=
AT+CREG?
AT+CKPD=
etc.

In an alternative, the new command “AT+HELP ATCmdSet” is replaced/supplemented by a set of three new AT commands, called for example “AT+HELP ATCmdFirst”, “AT+HELP ATCmdNext” and “AT+HELP ATCmdPrevious”. The latter make it possible for the device to request that the module send it the AT commands that it supports, one by one. As such:
if the device sends to the module the new command “AT+HELP ATCmdFirst”, the module sends back as a response a first command from the list of commands that it supports (the module sends back for example the command “AT+CPIN?”);
if the device sends to the module the new command “AT+HELP ATCmdNext”, the module sends back as a response the next command, in relation to a current command, from the list of commands that it supports (the module sends back for example the command “AT+CPIN=”);
if the device sends to the module the new command “AT+HELP ATCmdPrevious”, the module sends back as a response the previous command, in relation to a current command, from the list of commands that it supports (the module sends back for example the command “AT+CPIN?”).

Another new command, called for example “AT+HELP Command”, is such that if the device sends it to the module, the latter sends back as a response a list of input parameters (IN) and/or responses (OUT) associated with the command (of which the name is “Command”) indicated as an attribute of the new command “AT+HELP Command”.

Example: if the device sends the command “AT+HELP CPIN?”, the module responds by sending:
OUT=SIM READY/SIM PIN/SIM PUK/ERROR/CME ERROR . . .

Another example: if the device sends the command “AT+HELP CPIN=”, the response from the module may be one of the following responses:
IN=PIN, OUT=PIN READY/ERROR_{—}16/ERROR_{—}17 . . .
IN=PUK,PIN, OUT=IN_READY/ERROR_{—}16/ERROR_{—}17 . . .

Yet another new command, called for example “AT+HELP ATCmdItf”, is such that if the device sends it to the module, the latter sends back as a response an indication of the protocols and of the interface types on which the module supports AT commands.

For example, the AT commands supported by the module are by default as Raw Data protocol, but it can be considered to encapsulate them in the IP frames in order to have a module seen as a generic IP peripheral device.

Example: if the device sends the command “AT+HELP ATCmdItf”, the response from the module may be one of the following responses:
+ATCMDITF RS232,RaW (Raw Data on the RS232 link);
+ATCMDITF USB,RaW (Raw Data on the USB link);
+ATCMDITF GPRS,RaW/HTTP (Raw Data and HTTP supported through the GPRS link)
. . .

As such, in the first and second embodiments shown in FIG. 2, the steps of discovering and of driving are carried out thanks to the use of AT commands. As already discussed hereinabove, these two steps are carried out either by a same device, if they are both executed during a usage phase of this device, or each one by a separate device, if they are executed in a development phase and a usage phase respectively.

### 3. Implementation with Use of the Web Services Technology

In relation with FIG. 3, third and fourth embodiments of the method according to the invention are shown, based on the use of the Web services technology for the exchanges between the module 31 and a local device 32 (third embodiment), or between the module 31 and a remote device 33 (fourth embodiment).

The radio communication module 31 comprises:
a main radio communication application 311, also called “modem software” (such as in FIG. 2). With a concern for simplification, the storage (memory) and execution (CPU) resources of this main application, within the module 31, are not shown in FIG. 3;
a “USB” interface 315;
an “RS232” interface 316;
an “Ethernet” interface 3171;
a “GPRS” interface 318;
an “HTTP-TCP-IP” layer 314, above the “USB”, “RS232”, “Ethernet” and “GPRS” interfaces;
a “SOAP” layer 313, above the “HTTP-TCP-IP” layer;
a “Modem UF” layer (software interface layer) 312, above the “SOAP” layer;
a WSDL file 319.

In an alternative, the WSDL file 339 is stored on an external server, which can be accessed via an Internet address (referenced as 340 in FIG. 3).

The local device 33 comprises:
a local client application 331;
a “USB” interface 335;
an “RS232” interface 336;
an “Ethernet” interface 337;
a “HTTP-TCP-IP” layer 334, above the “USB”, “RS232”, “Ethernet” and “GPRS” interfaces;
a “SOAP” layer 333, above the “HTTP-TCP-IP” layer;
a “Modem Driver” (software driver layer) layer 332, above the “SOAP” layer.

The local device 33 is connected to the module 31 by the intermediary of a local link 35 (USB, RS232 or Ethernet link in this example), on which transit the requests and responses of the Web services type (exchanges according to the SOAP protocol).

The remote device 32 comprises:
a remote client application 321;
a “GPRS” interface 325;
a “HTTP-TCP-IP” layer 324, above the “GPRS” interface;
a “SOAP” layer 323, above the “HTTP-TCP-IP” layer;
a “Modem Driver” (software driver layer) layer 322, above the “SOAP” layer.

The “Modem Driver” layer 322, 332 of each of the devices 32, 33 is generated by a WSDL analyser 338, using the WSDL file.

The remote equipment 32 is connected to the module 31 by the intermediary of a remote link 34 (GPRS/IP link in this example), on which transit the requests and responses of the Web services type (exchanges according to the SOAP protocol).

With a concern for simplification, the storage (memory) and execution (CPU) resources of the local 331 and remote 321 client applications, within the local device 33 and remote device 32 respectively, are not shown in FIG. 3.

In order to implement the step of discovering (referred to as 1 in FIG. 1), the device 32 or 33 retrieves the WSDL file 319, 339 locally (case when stored on the module) or remotely (case with network storage).

The “SOAP” layers 313, 323 and 333 implement the SOAP protocol which is a message transmission protocol. It defines all of the rules for structuring messages that can be used in simple mono-directional transmissions, but it is particularly useful for executing RPC (Remote Procedure Call) request-response dialogs. This is the protocol for Web services messages.

The “Modem UF” layer 312 is a software layer implementing the service contract supported by the modem software, materialised by the WSDL file. In an embodiment, these are the AT commands exposed as Web services, which makes it possible to reuse existing commands. In another embodiment, it is an implementation of new interfaces supported by the modem software.

The “Modem Driver” layers 322, 332 are software interface layers created (for example automatically) using the WSDL file. They offer as a high interface the Web services discovered and encapsulate them in the SOAP protocol.

The set formed of the “SOAP” 323 and “Modem Driver” 322 layers (or “SOAP” 333 and “Modem Driver” 332) is the corollary for the set formed by the “SOAP” 313 and “Modem I/F” 312 layers: the first sends requests and the other processes them and sends back responses which are in turn processed by the first.

As such, in the third and fourth embodiments shown in FIG. 3, the steps of discovering and of driving are carried out thanks to the Web services technology. As already discussed hereinabove, these two steps are carried out either by a same device, if they are both executed during a usage phase of this device, or each by a separate device, if they are executed in a development phase and a usage phase respectively.

In an alternative (not shown), the step of discovering is carried out thanks to the Web services technology (operating in “Web service” mode) and making it possible to discover the AT interfaces, then the device switches to “AT command” mode on the link that was used to detect the commands (i.e. discover the AT interfaces). Finally, the device carries out the step of driving the module thanks to the AT commands. In other words, the available control interfaces of the module are described, in the WSDL file, by using the AT command syntax.

### 4. Implementation with the Use of the AT Commands and the Web Services Technology

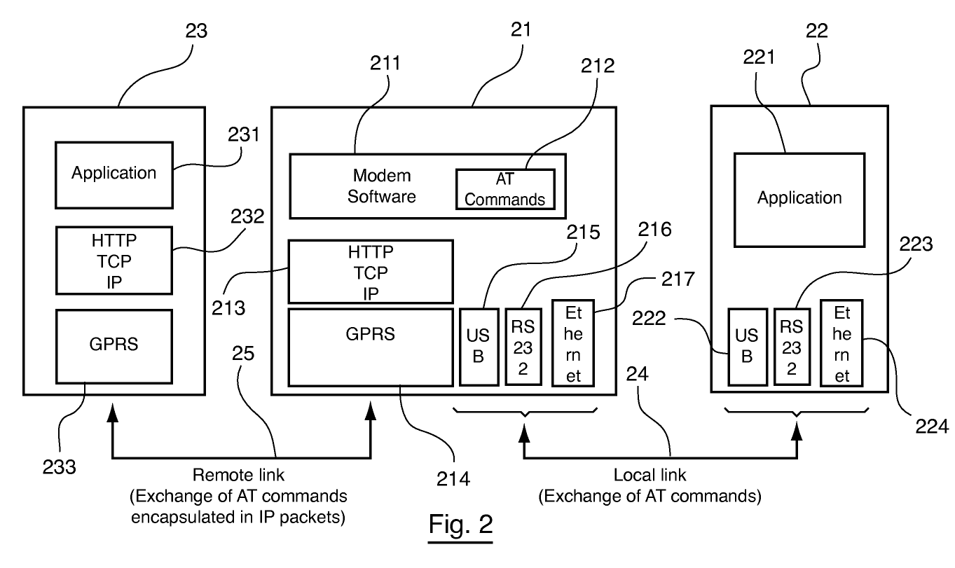

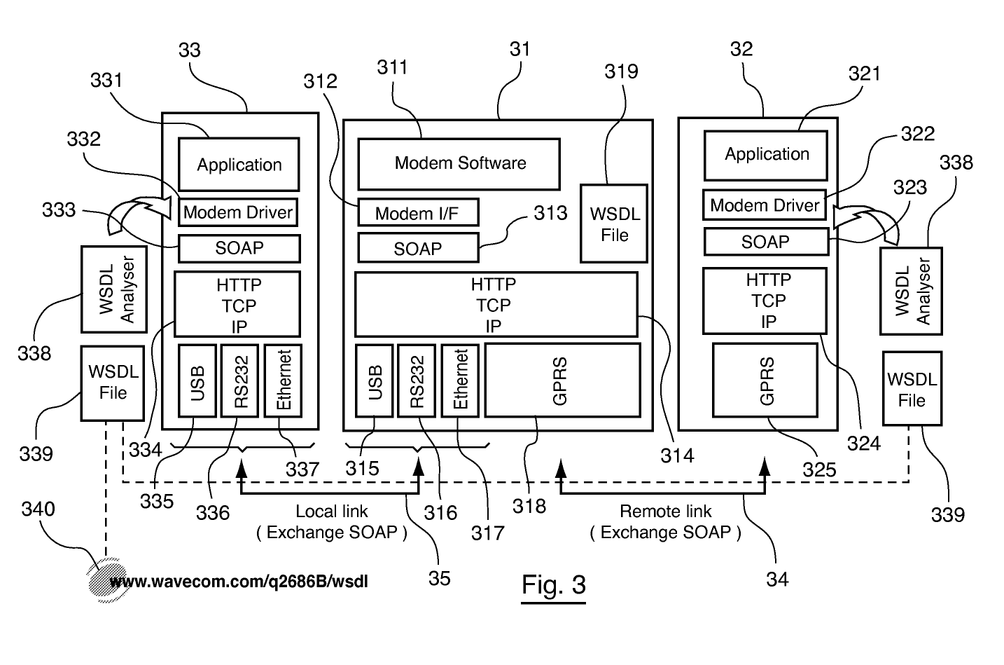

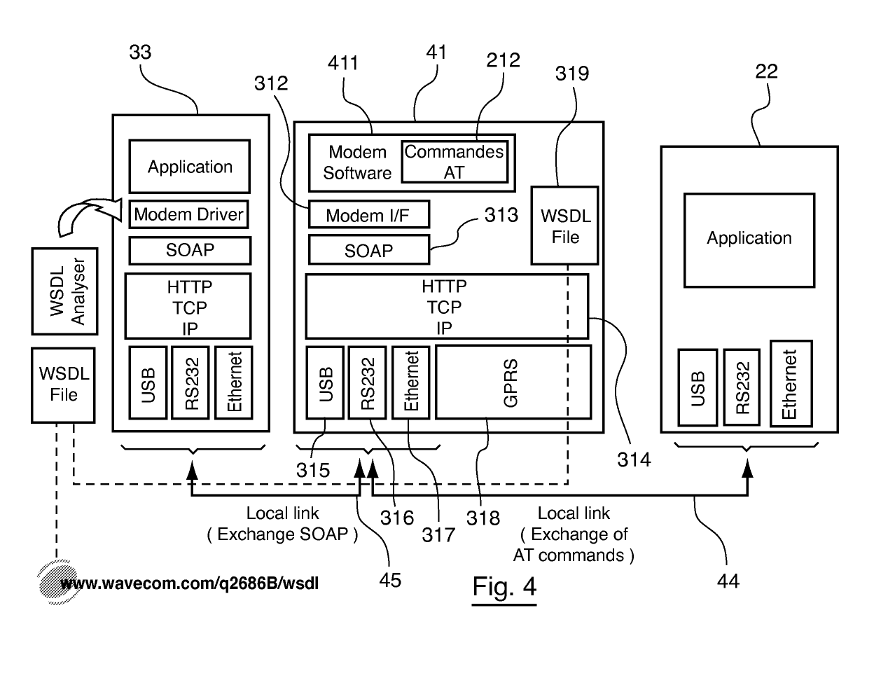

In relation with FIG. 4, a fifth embodiment of the method is shown according to the invention, wherein a same radio communication module 41 can be driven by two separate devices 22, 33. As such, it is compatible with the client applications driving it with AT commands, and with the client applications driving it with the Web services technology.

For the purposes of information, these two devices 22, 33 are local and identical to the devices bearing the same references in FIGS. 2 and 3 respectively. Therefore, they are not described again. In an alternative, one of the devices (or both) could be remote).

One 22 is connected to the module 41 by the intermediary of a first local link 44, on which AT commands transit. The other 33 is connected to the module 41 by the intermediary of a second local link 45, on which transit requests and responses of the Web services type (exchanges according to the SOAP protocol).

The module 41 comprises a combination of means (not described again) included in the modules 21 (FIG. 2) and 31 (FIG. 3) already described hereinabove. More precisely, it comprises:
a main radio communication application 411, itself comprising a portion 212 dedicated to the processing of AT commands;
a “USB” interface 315;
an “RS232” interface 316;
an “Ethernet” interface 317;
a “GPRS” interface 318;
a “HTTP-TCP-IP” layer 314, above the “USB”, “RS232”, “Ethernet” and “GPRS” interfaces;
a “SOAP” layer 313, above the “HTTP-TCP-IP” layer;
a “Modem I/F” (software interface layer) layer 312, above the “SOAP” layer;
a WSDL file 319.

### 5. Advantages of an Embodiment of the Invention

The diverted use, according to an embodiment of the invention, of the Web services technology for controlling a radio communication module by a device offers the following advantages:
it makes it possible to automatically discover the available interfaces (commands and responses) of a radio communication module;
it makes it possible to drive a module through any type of interface: local (via a serial link or USB for example), or remote through a wired or wireless radio communication network;
   the description file (WSDL) can be retrieved locally on the module or on a determined Internet site;
      the techniques for discovering (WS-Discovery), Metadata (WSMetadataTransfer), Security (WS-Security) and event feedback (WS-Eventing) defined by the OASIS organisation (“Organisation for the Advancement of Structured Information Standards”) can be used;
it makes it possible to unify the access to resources and therefore the interfaces offered;
it makes it possible to relocate the services offered;
it makes it possible to offer a more widely used and tooled programming interface than that of the standard AT commands;
the radio communication module acts as an end point that can be accessed by any Web client. The module becomes an IP module;
it facilitates the setting up of remote maintenance and development operations;
it makes it possible for an application to dynamically discover the interfaces offered by a radio communication module:
allows for greater flexibility in the elaboration of applications based on a set of devices (machines) that makes use of different access technologies: GSM/GPRS, Wifi, Bluetooth, Zigbee, UWB, etc.;
thanks to the service contract, an application can detect the methods, implemented by the various manufacturers for the same service; for example, the Simtoolkit AT commands are defined by each manufacturer, a discovery of the interfaces of the SATK family (Simtoolkit service), would allow the applications to adapt to the module used;
new modules can be added and identified dynamically by the application; which can then check the compatibility with the module detected as such;
it offers a more natural module programming interface for application developers than in the case of the AT commands, while still remaining independent of the hardware architecture (HW) and of the operating system (OS) chosen for the application and the module:
dual-processor architecture, for example for a PDA or Smartphone, with Linux (registered trademark) or Windows (registered trademark), required a specific driver for each module used. The use of the Web services technology greatly simplifies writing these drivers, with the specific driver becoming trivial (limited a hardware interface);
many tools and libraries are already available for the Web services technology, which renders the use of this technology trivial for the wireless application developers;
mono-processor architecture on an operating system (OS) of the “Wavecom Open AT” type (registered trademark): the client application on board the module exposes its business functions in the form of Web services. Example, a module with a client application for managing a water or electricity meter exposes its Web services interfaces to a local or remote data collection system (see hereinabove the description of FIG. 6 which shows this application);
possibility of automating tests. Once these interfaces are discovered, it is possible to launch an automated test campaign;
the available interfaces can be of different levels, for example initially, certain interfaces appear, and then when a secret key is entered a wider set of interfaces can become available. In the first interface level, a special API would be declared in order to confirm access to higher levels;
combined with the security standards used in the Web services technologies, access to the interfaces and therefore to the modem commands can be secured: Web services over Https (SSL or TLS).

In summary, at least one embodiment of the present disclosure therefor provides a technique for controlling a radio communication module by a device, making it possible to facilitate the development of the application executed by this device.

At least one embodiment provides such a technique making it possible to drive the module by the device, through any type of interface, locally or remotely.

At least one embodiment provides such a technique, that is simple to implement and of low cost.

At least one embodiment provides such a technique making it possible for the device to dynamically adapt its operation according to the module to which it is effectively connected (and the available control interfaces of this module).

### 6. Annex 1

### AT & WSDL Mapping Commands

### Definitions

AT commands: Describes a set of commands and responses for driving a modem
WSDL—Definition: Formally describes the content of the messages (SOAP formalism, standardised structure of XML messages) of a service, describes the protocols and addresses used for the service.

### WSDL Description

| WSDL Element | Description | Open AT Analogy | Proposal |
|---|---|---|---|
| Type | Definition of the types of | Set of structured | Definition of the |
| | data (based on XML | types | structured types |
| | schema) used by the service | | needed to exchange |
| | | | data with the |
| | | | modem |
| Message | Abstract definition of a typed | Types structure | Definition of |
| | data structure used to | | typical commands |
| | communicate with the | | with the modem |
| | service | | |
| Operation | Description of an action | Function | Definition of the |
| | proposed by the service | In RPC mode: | commands |
| | Name | each part of the | provided by the |
| | Incoming message [possible] | messages | modem and |
| | Outgoing message [possible] | correspond to a | associated |
| | | parameter: input | responses |
| | | or return | |
| Port Type | All of the “abstract” | API | Set of commands |
| | operations (not linked to a | Independent layer | available on the |
| | transport protocol or to an | of the transport | modem |
| | address) | protocol | There can be |
| | | | several of these for |
| | | | the purposes of |
| | | | structuring |
| Binding | Association of a “Port Type” | Protocol | Choice of http or |
| | with a transport protocol and | | Https, Document |
| | encoding style | | style |
| | e.g.: HTTP & rpc or | | |
| | document | | |
| Port | Association of a Binding | Server | URL of the modem |
| | with a service address: URL | | in the user network |
| Service | Set of ports | Back end | The Modem |
| | Same “Port type” with | | |
| | several Bindings = | | |
| | alternative | | |

### 7. Annexe 2

### Example of Porting as Web Services a Simple AT Command to Enter the PINcode of the Modem

Command:
AT+CPIN=PIN code
Or AT+CPIN=PUK code, new PIN code
Or AT+CPIN?

Response:
OK or status string

1) WSDL Description of the Pin Modem Service without Reusing the AT Command Syntax

<?xml version= ″1.0″ encoding=″UTF-8″?>
<!-- WSDL description of the Wavecom GSM/GPRS modem Web API.

This API is drafted for example purpose only. -->

<!-- Definitions and used namespaces used by the API -->

| <!-- | tns | : type name space |
|---|---|---|
| | xsd | : schema name space |
| | soap | : soap name space |
| | wsdl | : wsdl name space --> |

<definitions name=″urn:WisMoCommand″

targetNamespace=″urn:WisMoCommand″
xmlns=″http://schemas.xmlsoap.org/wsdl/″
xmlns:tns=″urn:WisMoCommand″
xmlns:xsd=″http://www.w3.org/2001/XMLSchema″
xmlns:soap=″http://schemas.xmlsoap.org/wsdl/soap/″
xmlns:wsdl=″http://schemas.xmlsoap.org/wsdl/″ >

<!-- Types for AT command parameters and received results -->
<!-- Defined with schemas -->
<types>

<xsd:schema targetNamespace=″urn:WisMoCommand″>

<xsd:element name=″PINCode″ type=″xsd:string″ />
<xsd:element name=″PUKCode″ type=″xsd: string″ />
<xsd:element name=″PINReady″ type=″xsd:boolean″ />
<xsd:element name=″PINErrorCode″ type=″xsd:string″ />
<xsd:complexType name=″PINStatus″>

<xsd:sequence>

<xsd:element name=″isPinReady″ type=″tns:PINReady″/>
<xsd:element name=″errorCode″ type=″tns:PINErrorCode″/>

</xsd:sequence>

</xsd:complexType>

</xsd:schema>

</types>
<!-- Messages for PIN management API -->
<!-- AT+CPIN? -->
<message name=″GetPinStatus″>
</message>
<!-- AT+CPIN=″xxxx″ -->
<message name=″EnterPIN″>

<part name=″PIN″ type=″tns:PINCode″ />

</message>
<!-- AT+CPIN=″xxxxxxxx″, ″xxxx″ -->
<message name=″EnterPUK″>

<part name=″PUK″ type=″tns:PUKCode″ />
<part name=″PIN″ type=″tns:PINCode″ />

</message
<!-- AT+CPIN message response -->
<message name=″PINResult″>

<part name=″Result″ type=″tns:PINStatus″ />

</message>
<!-- Port AT Command API -->
<portType name=″WisMoCommandPort″>

<operation name=″doGetPINStatus″>

<input message=″tns:GetPinStatus″ />
<output message=″tns:PINResult″ />

</operation>
<operation name=″doEnterPIN″>

<input message=″tns:doEnterPIN ″ />
<output message=″tns:PINResult″ />

</operation>
<operation name=″doEnterPUK″>

<input message=″tns:doEnterPUK″ />
<output message=″tns:PINResult″ />

</operation>

</portType>
<!-- Binding with Document/literal SOAP over HTTP -->
<binding name=″WisMoCommandBinding″ type=”tns:WisMoCommandPort”>

<soap: binding style=”document”

transport=”http://schemas.xmlsoap.org/soap/http” />

<operation name=″doGetPINStatus″>

<soap:operation soapAction=”urn:WisMoCommand” />
<input>

<soap:body use=”literal”/>

</input>
<output>

<soap:body use=”literal” />

</output>

</operation>
<operation name=″doEnterPIN″>

<soap: operation soapAction=”urn:WisMoCommand” />
<input>

<soap:body use=”literal”/>

</input>
<output>

<soap:body use=”literal” />

</output>

</operation>
<operation name=″doEnterPUK″>

<soap:operation soapAction=”urn:WisMoCommand” />
<input>

<soap:body use=”literal”/>

</input>
<output>

<soap:body use=”literal” />

</output>

</operation>

</binding>
<!-- Endpoint as example -->
<service name=”WavecomModem” >

<port name=”WisMoCommandPort” binding=”tns:WisMoCommandBinding” >

<soap:address

location=”http://localhost:8080/WavecomModem/WisMoCommand/” />

</port>

</service>
</definitions>

2) WSDL Description of the PIN Modem Service by Reusing the AT Command Syntax

<?xml version= ″1.0″ encoding=″UTF-8″?>
<!-- WSDL description of the Wavecom GSM/GPRS modem Web API.

This API is drafted for example purpose only. -->

<!-- Definitions and used namespaces used by the API -->

| <!-- | tns | : type name space |
|---|---|---|
| | xsd | : schema name space |
| | soap | : soap name space |
| | wsdl | : wsdl name space --> |

<definitions name=″urn:WavecomATCommand″

targetNamespace=″urn:WavecomATCommand″
xmlns=″http://schemas.xmlsoap.org/wsdl/″
xmlns:tns=″urn:WavecomATCommand″

xmlns:xsd=″http://www.w3.org/2001/XMLSchema″
xmlns:soap=″http://schemas.xmlsoap.org/wsdl/soap/″
xmlns:wsdl=″http://schemas.xmlsoap.org/wsdl/″ >

<!-- Types for AT command parameters and received results -->
<!-- Defined with schemas -->
<types>

<xsd:schema targetNamespace=″urn:WavecomATCommand″>

| | |
|---|---|
| <xsd:element name=″ATCommand″ | type=″xsd:string″ /> |
| <xsd:element name=″ATResponse″ type=″xsd:string″ /> | |
| <xsd:element name=″ATUnsolicited″ | type=″xsd:string″ /> |

</xsd:schema>

</types>
<!-- Messages for AT Requests management API -->
<message name=″ATCommand″>

<part name=″Command″ type=″tns:ATCommand″ />

</message>
<!— Message for AT Response management API -->
<message name=″ATResponse″>

<part name=″Result″ type=″tns:ATResponse″ />

</message>
<!— Message for AT Unsolicited management API -->
<message name=″ATUnsolicited″>

<part name=″Unsolicited″ type=″tns:ATUnsolicited″ />

</message>
<!-- Port AT Command API -->
<portType name=″WavecomATCommandPort″>

<operation name=″doSendCommand″>

<input message=″tns:ATCommand″ />
<output message=″tns:ATResponse″ />

</operation>
<operation name=″getUnsolicited″>

<output message=″tns:ATUnsolicited″ />

</operation>

</portType>
<!-- Binding with Document/literal SOAP over HTTP -->
<binding name=″WavecomATCommandBinding″ type=”tns:
WavecomATCommandPort”>

<soap:binding style=”document”

transport=”http://schemas.xmlsoap.org/soap/http” />

<operation name=″doSendCommand ″>

<soap:operation soapAction=”urn:WavecomATCommand” />
<input>

<soap:body use=”literal”/>

</input>
<output>

<soap:body use=”literal” />

</output>

</operation>
<operation name=″getUnsolicited ″>

<soap:operation soapAction=”urn:WavecomATCommand” />
<output>

<soap:body use=”literal” />

</output>

</operation>

</binding>
<!-- Endpoint as example -->
<service name=”WavecomATModem”>

<port name=”WavecomATCommandPort” binding=”tns:WavecomATCommandBinding” >

<soap:address

location=”http://localhost:8080/WavecomModem/WavecomATCommand/” />

</port>

</service>
</definitions>

Although the present disclosure has been described with reference to one or more examples, workers skilled in the art will recognize that changes may be made in form and detail without departing from the scope of the disclosure and/or the appended claims.

1. Method for controlling an electronic radio communication module by a first device, comprising:
a step of discovering by a second device of available control interface(s) of said module, said second device being the same as or separate from said first device, wherein said step of discovering comprises a step of obtaining by the second device of a description file containing the available control interface(s) of said module,
wherein said description file is a WSDL file describing the available control interface(s) of said module in a form of at least one Web service hosted by said module.

2. Method set forth in claim 1, wherein each available control interface of said module is defined by:
a set of commands supported by the module;
a physical interface of the module on which said set of commands is supported;
a protocol on which said set of commands is supported.

3. Method according to claim 1, wherein said second device obtains the description file:
locally, by a connection between the second device and the module, said description file being stored by the module; or
remotely, by a connection between the second device and another remote device, said description file being stored by said other remote device.

4. Method as set forth in claim 1, said module hosting and executing a main radio communication software and an on-board client software, wherein said WSDL file describes at least one Web service which is provided by said client software and which uses at least one available control interface of the module.

5. Method as set forth in claim 1, wherein said at least one Web service is described, in said WSDL file, by reusing the AT command syntax.

6. Method as set forth in claim 1, wherein said at least one Web service is described, in said WSDL file, by using a syntax that is separate from that of the AT commands.

7. Method as set forth in claim 1, wherein said step of discovering is followed by the following steps:
selecting of a control interface of the module, from among the available control interface(s) discovered beforehand;
driving said module by said first device, according to the control interface selected.

8. Method set forth in claim 7, wherein said steps of discovering and of selecting are carried out with said second device, during a development phase of an application and/or a software layer on which is based said application, intended to be hosted and executed by said first device, said step of selection being carried out by a developer, said development being according to the control interface selected,
and wherein said step of driving is carried out during a later usage phase of said first device in cooperation with said module.

9. Method set forth in claim 7, wherein the second device is the same as the first device,
and wherein the said steps of discovering, selecting and driving are carried out during a usage phase of said first device in cooperation with said module, said step of selecting being carried out automatically and dynamically by said first device, according on the one hand to a predetermined selection policy and on the other hand to the available control interface(s) discovered.

10. Device able to cooperate with an electronic radio communication module, wherein the device comprises means of discovering the available control interface(s) of said module, in such a way as to make it possible to control said module by said device or by another device,
wherein said means of discovering include means of obtaining by said device of a description file containing the available control interface(s) of said module,
and said description file is a WSDL file describing the available control interface(s) of said module in the form of at least one Web service hosted by said module.

11. Device set forth in claim 10, wherein each available control interface of said module is defined by:
a set of commands supported by the module;
a physical interface of the module on which said set of commands is supported;
a protocol on which said set of commands is supported.

12. Device as set forth in claim 10, wherein the device further comprises:
means of selecting a control interface of the module, from among the available control interface(s) discovered beforehand;
means of driving said module according to the control interface selected.

13. Electronic radio communication module, being able to be controlled by a first device, wherein the module hosts at least one Web service, a WSDL file describing the available control interface(s) of said module in the form of said at least one Web service.

14. Module set forth in claim 13, said module hosting and executing a main radio communication software and an on-board client software, wherein said WSDL file describes at least one Web service which is provided by said client software and which uses at least one available control interface of the module.

15. Recording support containing a description file associated with an electronic radio communication module, said module being of the type able to be controlled by a first device, said description file being a WSDL file describing the available control interface(s) of said module in the form of at least one Web service hosted by said module, said description file being intended to be stored locally on the module or remotely on another device,
said file being obtainable by a second device, the same as or separate from said first device, in such a way as to allow said first device to control the module.

16. Recording support set forth in claim 15, said module hosting and executing a main radio communication software and an on-board client software, wherein said WSDL file describes at least one Web service which is provided by said client software and which uses at least one available control interface of the module.

17. Recording support as set forth in claim 15, wherein said at least one Web service is described, in said WSDL file, by reusing the AT command syntax.

18. Recording support as set forth in claim 15, wherein said at least one Web service is described, in said WSDL file, by using a syntax that is separate from that of the AT commands.
